(19) United States
(12) Patent Application Publication
(10) Pub. No.: US 2016/0188188 A1
(43) Pub. Date: Jun. 30, 2016

(54) PATIENT USER INTERFACE FOR CONTROLLING A PATIENT DISPLAY

(71) Applicant: KONINKLIJKE PHILIPS N.V., Eindhoven (NL)

(72) Inventors: Eike Marieke Lambert Daemen, Meerhout (BE); Roel Peter Geert Cuppen, Venlo (NL); Jia Du, Waalre (NL); Wilco Boeije, Eindhoven (NL); Evert Jan Van Loenen, Waalre (NL)

(21) Appl. No.: 14/902,872

(22) PCT Filed: Jul. 2, 2014
(86) PCT No.: PCT/EP2014/064098

§ 371 Date: Jan. 26, 2016

(30) Foreign Application Priority Data
Jul. 5, 2013 (EP) 13175265.1

(51) Int. Cl. G06F 3/0484; G06F 3/14; G06F 3/0482

(52) U.S. Cl. CPC G06F 3/04847; G06F 3/0482; G06F 3/04842; G06F 3/1446

(57) ABSTRACT

The invention relates to a user interface (100) for use by a patient, e.g. a stroke victim, for controlling video and images displayed on a patient display (170). The user interface includes display components (111-113) for displaying images and video created from visual object data. The display components are selectable by the patient so that by selection of display component, images or video displayed on the display component will be displayed in full on the patient display. The user interface is configured so that the display components resemble corresponding display units (171-173) of the patient display. The display components and other buttons may have a size and may be centered in the user interface (100) to ease use of the user interface for patients having a reduced ability to operate buttons on a user interface.

### FIELD OF THE INVENTION

The invention relates to user interfaces and display systems for controlling visual content on a display, particularly to such systems for use by patients with reduced physical and cognitive capabilities for operating a user interface.

### BACKGROUND OF THE INVENTION

Patients in a hospital may be entertained by video presented on a display. The patient may also have access to a user interface such as a remote control for controlling what to be displayed on the display.

However, patients with reduced physical and cognitive capabilities for operating a user interface such as stroke patients may have difficulties in operating a normal remote control.

Therefore, it may be preferred that such patients do not have access to any user interface for controlling the display. This may be disadvantageous since patients may gain a more positive experience when patients have at least some control on the environment, e.g. control of what is displayed on the patient display. Further, having a feeling of control may also have a positive effect on the healing process.

Accordingly, there is a need for improved display controllers for patients with reduced physical and cognitive capabilities.

WO2012176098 discloses an ambience creation system capable of creating an atmosphere in a patient room which doses the sensory load depending on the patient status, e.g. healing status such as the patient's condition, pain level, recovery stage or fitness. The atmosphere can be created by the ambience creation system capable of controlling lighting, visual, audio and/or fragrance effects in the room. The state of the atmosphere may be determined from sensor measurements, e.g. measurements of the patient's body posture, bed position, emotions or the amount of physical activity. The state of the atmosphere may also be determined from information retrieved from a patient information system which contains patient status information. Such a patient information system can either be kept up to date by the hospital staff or by data reported on by the patient itself as patient feedback e.g. on perceived pain level. A user interface for the hospital staff for setting a state of an ambient stimuli device is also disclosed.

WO2012103121 discloses an information delivery system for interaction with multiple information forms across multiple types, brands, and/or models of electronic devices, such as mobile devices, portable devices, desktop computers, and televisions. The information delivery system provide the display of and access to secure user-centric information via the construct of a channel grid framework serving as a desktop on a user device. The channel grid framework includes multiple user-selectable items that provide access to corresponding “channels” by which respective portions of user-centric information are delivered to a user. The information delivery system of the invention may be suitable for consumer applications and/or enterprise applications.

The inventor of the present invention has appreciated that an improved patient systems is of benefit, and has in consequence devised the present invention.

### SUMMARY OF THE INVENTION

It would be advantageous to achieve improvements within in patient systems. It would also be desirable to enable patients to control patient displays. In general, the invention preferably seeks to mitigate, alleviate or eliminate one or more of the above mentioned disadvantages of normal remote controls used for patients. In particular, it may be seen as an object of the present invention to provide a method that solves the above mentioned problems, or other problems, of the prior art.

To better address one or more of these concerns, in a first aspect of the invention a user interface is presented for enabling a patient to control a patient display located in front of the patient, wherein
the user interface is processable by a user display to display the user interface, wherein the user display is responsive to generate data derived from patient interaction with the user interface, and wherein the user display comprises a transmitter for transmitting the data derived from patient interaction with the user interface and a receiver for receiving visual object data, wherein the user interface comprises
a display component for displaying visual objects created from the visual object data, wherein the display component is selectable by the patient for selection of different visual objects, and wherein the display component is synchronized with the patient display so that the visual object displayed on the display component and visual content shown on the patient display are determined from the same visual object data.

Advantageously, the synchronization may make it easier for patients with reduced physical and cognitive capabilities to use the user interface since the user interface and patient display may display the same or corresponding image material.

The synchronization of the display component with the patient display may be achieved by the transmitter and receiver.

In an embodiment the user interface is for enabling the patient to control the visual content on first and second display units of the patient display, wherein the user interface comprises
at least first and second a display components for displaying at least first and second visual objects created from the visual object data, wherein the first and second display components are selectable by the patient for selection of different visual objects for each of the first and second display components, and wherein the first and second display components are synchronized with the first and second display units so that the visual objects displayed on the first and second display components and the visual content shown on the first and second display units are determined from the same visual object data.

The user interface may be configured to enable different visual objects to be displayed on the first and second display components and the synchronized first and second display units simultaneously. That is, the user may have selected different visual objects, e.g. in the form of one or more different video scenes, for the first display component and different visual objects, e.g. in the form of one or more different still images, for the second display component so that selected visual objects are displayed simultaneously on both the first and the second display component and on the synchronized first and second display units. Alternatively, the user interface may be configured so that selected different visual objects can only be displayed on one of the first and second display components and one of the synchronized first and second display units e.g. in order to limit the visual impact on the user. The active display component and corresponding display unit may be determined as the display component that has been selected most recently.

Due to the synchronization the visual content shown on the first and/or second display units and the visual objects shown on the respective first and/or second display components are determined from the same visual object data or from the same respective first and second visual object data. That is, visual content shown on the first display unit and the visual objects shown on the first display component may be determined from the same first visual object data, e.g. video data. Similarly, visual content shown on the second display unit and the visual objects shown on the second display component may be determined from the same second visual object data, e.g. still image data, which are different from the first visual object data.

For patient displays including two displays for displaying different types of image content, a user interface with corresponding two display components may ease the use for patients with reduced physical and cognitive capabilities, particularly when the displays on a wall are synchronized with the display components.

In an embodiment the user interface further comprises a settings component being selectable by the patient for setting characteristics of the patient display, wherein the settings component is configured so that selection of the settings component causes a presentation on the user interface of different setting buttons associated with the characteristics of the patient display.

In an embodiment the user interface further comprises a selection display for displaying selectable visual objects for the first and second display components and for displaying the setting buttons associated with the settings component, wherein the user interface is configured so that the selectable visual objects for the first display component are displayed in response to selection of the first display component, so that the selectable visual objects for the second display component are displayed in response to selection of the second display component, and so that setting buttons are displayed in response to selection of the setting component.

In an embodiment the user interface is configured to display one or more of the selectable visual objects and/or setting buttons in the center of the selection display.

In an embodiment the user interface is configurable to display one or more of the at least first and second a display components. Accordingly, the user display may be configured, e.g. by personnel, to present one, two or more display components, e.g. depending on the patient's capabilities.

In an embodiment the user interface is configurable so that an available number of setting buttons and/or an available number of selectable visual objects is configurable.

In an embodiment the user interface is configurable based on patient parameters retrievable by the user interface from a database. The patient parameters may be provided from measured conditions of a patient.

A second aspect of the invention relates to a patient experience system, comprising
a user interface according to the first aspect,
a user display for displaying the user interface, wherein the user display is responsive to generate data derived from patient interaction with the user interface, and wherein the user display comprises a transmitter for transmitting the data derived from patient interaction with the user interface and a receiver for receiving visual object data, and
a patient display configured to be located in front of the patient.

A third aspect of the invention relates to a method for controlling a patient display located in front of a patient by use a user display having a user interface, wherein the user display comprises a transmitter for transmitting interaction data derived from patient interaction with the user interface and a receiver for receiving visual object data, wherein the method comprises
displaying a display component for displaying visual objects created from the visual object data, wherein the display component is selectable by the patient for selection of different visual objects,
generating first interaction data in response to the patient's selection of the display component,
in response to the first interaction data, displaying selectable visual objects,
generating second interaction data in response to the patient's selection of one or more of the visual objects,
in response to the second interaction data, displaying the selected visual objects on the selected display component and displaying visual content on the patient display, wherein the visual objects displayed on the display component and the visual content displayed on the patient display are determined from the same visual object data.

A fourth object of the invention relates to a computer program product comprising program code instructions which when executed by a processor of a user display enables the user display to carry out the method of the third aspect.

A fifth object of the invention relates to a computer-readable medium comprising a computer program product according to the fourth aspect. The computer-readable medium may be a non-transitory medium.

A sixth aspect of the invention relates to user display comprising the user interface of the first aspect.

In general the various aspects of the invention may be combined and coupled in any way possible within the scope of the invention. These and other aspects, features and/or advantages of the invention will be apparent from and elucidated with reference to the embodiments described hereinafter.

In summary the invention relates to a user interface for use by a patient, e.g. a stroke victim, for controlling video and images displayed on a patient display. The user interface includes display components for displaying images and video created from visual object data.

The display components are selectable by the patient so that by selection of display component, images or video displayed on the display component will be displayed in full on the patient display. The user interface is configured so that the display components resemble corresponding display units of the patient display. The display components and other buttons may have a size and may be centered in the user interface to ease use of the user interface for patients having a reduced ability to operate buttons on a user interface.

### BRIEF DESCRIPTION OF THE DRAWINGS

Embodiments of the invention will be described, by way of example only, with reference to the drawings, in which

FIG. 1 shows a user interface 100 for controlling a patient display 170, and

FIGS. 2A-B show how buttons 201 and selectable visual content 202 may be displayed in the user interface.

### DESCRIPTION OF EMBODIMENTS

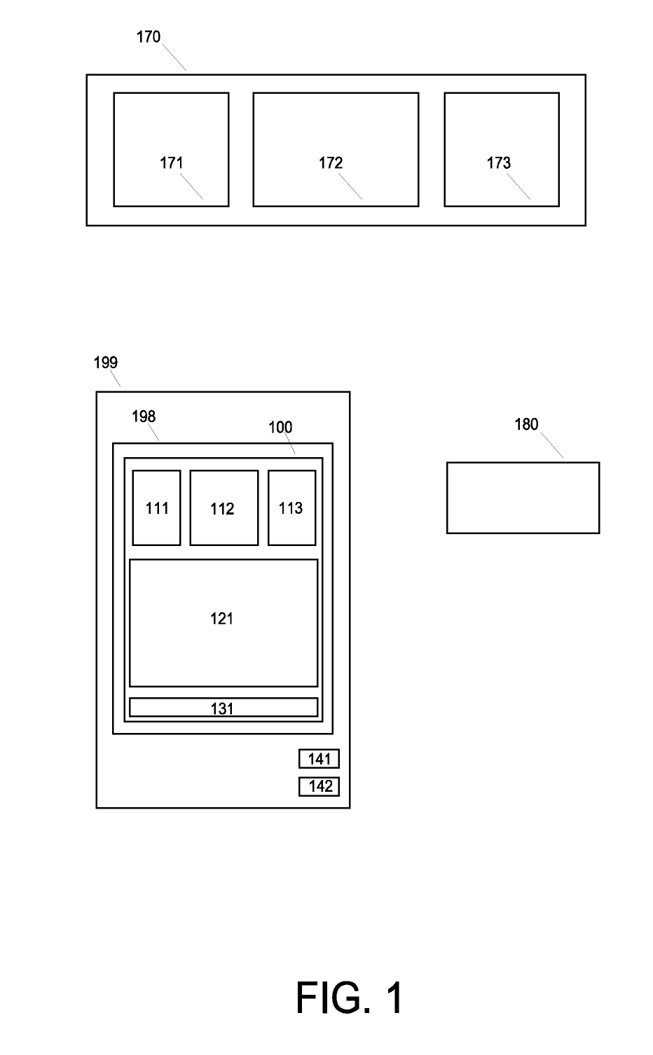

FIG. 1 shows a user interface 100 configured to enable a patient to control a patient display 170 located in front of the patient. The control may comprise control of visual content, audio and/or ambient lighting from cove lighting integrated in the patient display 170. The user interface 100 is particularly configured for patients which are not capable of operating a normal user interface or remote control or which have reduced capabilities for operating a user interface. Such patients may be stroke patients or other patients whose ability to operate buttons on a user interface is reduced. In general, the user interface 100 may be particularly useful for any type of patient with a neurological disorder. The patient display 170 may be a display, e.g. a LCD display, capable of displaying image and video data and may be configured with an audio amplifier and speakers. The display may 170 may be a single display unit or may consist of one or more display units 171-173 capable of displaying different image and/or video data, i.e. different visual content, on different display units. The display 170 may be configured to be integrated in a wall and, therefore, particularly suited for use in hospitals or other care-giving environments.

The user interface 100 is enabled by a computer program product comprising program code instructions which when executed by a processor of a user display 199 enables the user display to display the user interface and to perform functions of the user interface. The computer program product may be stored on the user display, i.e. stored on a non-transitory computer-readable medium. The user display may be a mobile display such as a smart phone, a tablet or other mobile display which can be carried by the patient, or the user display may be a stationary display such as a computer screen. The user display 199 comprises a screen 198 such as an LCD screen for displaying visual content.

The user interface 100 comprises one or more display components 111-113. One or more of the display components 111-113 are configured for displaying visual objects such as video or images. The visual objects are created from the visual object data. One or more of the display components are selectable by the patient via patient interaction for selection of different visual objects. Thus, a visual object may refer to a still image, a slide show of still images, video or other types of visual content which can be displayed.

Selection by patient interaction may be achieved by a touch sensitive screen 198 in the user display 199, where the screen 198 is responsive to the patient's finger touch on the screen. Alternatively or additionally, the patient interaction may be achieved by a camera 181 or other device capable of tracking the user's eye movement so that selection of a display component 111-113 can be performed use of the eyes, e.g. by directing the view towards a given display components and blinking. Alternatively or additionally, the patient interaction may be achieved by other techniques such as tongue or mouth control systems 182 wherein the patient is able to select a given display component by tongue movement. The eye tracking device, tongue control system or other device capable of detecting patient interaction may be comprised by or operable with the display 199. For example, eye tracking may be embodied by a camera integrated with the user display 199.

Thus, the user display 199 is configured to display the user interface 100 and the display 199 is responsive to generate the data derived from patient interaction with the user interface or the display component of the user interface by means of touch screen functionality, eye tracking functionality or other functionality for detection patient interaction with the user interface.

The user display 199 may further comprise a transmitter 141 for transmitting data derived from patient interaction with the user interface—e.g. data indicating selection of a given display component—and a receiver 142 for receiving visual object data for creating video or images to be shown by the user interface 100.

The visual object data may be stored on a database 180. The database may be a central database, or the database may be part of the user display 199 or the patient display 170. In case the database is a separate central database, the database 180 may be configured with a transmitter for transmitting the object data to the user display 199 and a receiver for receiving patient interaction data from the user display 199 derived from patient interaction with the user interface 100. The database 180 may also be configured to transmit visual object data to the patient display 170.

For example, the user interface 100 may be configured by webpages that are served on a web server. The content of these web pages may be determined from data stored on a database relating to selections on the user interface, patient data or relating to other input. This database is checked regularly to determine if the state and choices in the user interface have changed. If something has changed (e.g. a theme choice, intensity change, and color change) then the corresponding output is changed on the patient wall (e.g. nature pictures in center screen, lighting conditions of patient wall).

The one or more display components 111-113 may be synchronized with the patient display 170 or the display units 171-173 so that the same visual object is displayed on a given display component and the patient display. For example, the center display unit 172 and the center display component 112 may display the same video and the right display unit 172 may display the same image or images as displayed on the right display component.

Alternatively, the display components 111-113 may be synchronized with the patient display 170 so that both a display component 111-113 and a display unit 171 shows image content derived from the same visual object data for example, so that only a fraction of the entire visual object data is displayed by a display component 111-113 whereas the entire visual object data is displayed on the display unit 171-173. For example, a still image may be extracted from the visual object data and displayed on a display component whereas the video content of the visual object data is displayed on the display unit.

The synchronization may be invoked as soon as a selection of visual content, e.g. selection of video or images, has been made by the patient.

Synchronization between the display components 111-113 and the display units 171-173 may be achieved by the transmitter and receiver of the user display and by configuring the database to transmit the same visual object data both to the user display 199 and the patient display 170. For example, when a display component has been selected by user interaction and a given visual object has been selected (described in detail below), information about the selected visual object may be transmitted via the transmitter 141 of the user display 199 to the database. In response to receiving information about the selected visual object, the database may transmit visual object data corresponding to the selected visual object to the user display 199 and the patient display 170 (via the receiver 142 and a corresponding receiver of the patient display).

The transmitter 141 and receiver 142 may be configured to transmit and receive data via a wireless or wired connection. In case that the database 180 is part of the user display 199 the transmitter 141 and receiver 142 may be part of integrated circuits in the user display.

In an example of an embodiment the user interface 100 may have three display components 111-113 which resembles three display units 171-173 of the patient display 170 with respect to relative sizes, geometries, relative positions and visual content being displayed. The user interface may further have a selectable settings component 131 and a selection display 121.

The settings component 131 is selectable by the patient for setting lighting characteristics of the ambient cove lighting of the patient display 170 and/or audio characteristics of the patient display 170, e.g. sound volume associated with all or individual display units 171-173. The lighting characteristics of the ambient cove lighting include color and intensity settings. The settings component may be configured so that selection of the settings component causes a presentation on the user interface of different buttons associated with the characteristics of the patient display 170.

The selection display 121 is for displaying selectable visual objects for one or more of the display components 111-113 and for displaying the buttons of the settings component 131.

A first display component 112 (associated with the first display unit 172) may be configured for selection of different video themes, e.g. nature themes. A video theme may consist of pictures, slideshows and/or video; and a video theme can be with or without audio. In response to selection of the first display component 112, different selectable video themes are displayed in the selection display 121 as selectable buttons showing image or video content of the theme. The patient can select one or more of these video themes by user interaction, e.g. by touching theme buttons or directing the view towards a theme button. The user interface 100 may be configured so at when a theme button has been selected the video associated with the button will be displayed on the first display unit 172 in the patient room. The selected video may also be displayed on the first display component or image content (e.g. a still image) extracted from the visual object data corresponding to the selected video may be displayed on the first display component.

A second display component 113 (associated with the first display unit 172) may be configured for selection of different images (e.g. drawings) sent to the patient by other people, e.g. family or relatives. The second display component 113 may have functionality similar to the first display component 112. Thus, in response to selection of the second display component 113, different selectable images, i.e. connectivity images are displayed in the selection display 121 as selectable image buttons (also referred to as selectable visual objects 202) showing e.g. the image or part of it. The patient can select one or more of these images. The user interface 100 may be configured so at when an image button has been selected the image associated with the button is displayed on the second display unit 173 and also on the second display component 113. A selected plurality of images may be displayed in order of selection.

Definition: A visual object refers generally to image content derivable visual object data e.g. video derivable from video data, which can be displayed on the display components 111-113 and patient screens 171-171. A selectable visual object 202 refers to selectable image buttons 202 which are displayed or can be displayed on the user interface 100, e.g. on the selection display 121.

The user interface 100 may be configured so that different videos or images can be selected from the selection display e.g. by a scrolling functionality whereby video or image buttons can be scrolled from right to left by use of user interaction. Further, the user interface may be configured so that when the patient taps on a button, the video theme or image associated with the button is selected. The button can be deselected again by tapping on the button again.

A third display component 111 may be non-selectable and configured to shows various information such as time, day-schedules of planned activities, etc. The visual content displayed on the third display component may also be displayed on the corresponding first display unit 171.

Thus, the user interface 100 may be configured so that selectable visual objects (e.g. different video themes) for the first display component 112 are displayed (on the selection display 121 or elsewhere) in response to selection of the first display component, so that the selectable visual objects (e.g. connectivity images) for the second display component 113 are displayed in response to selection of the second display component and so that buttons are displayed in response to selection of the setting component 131.

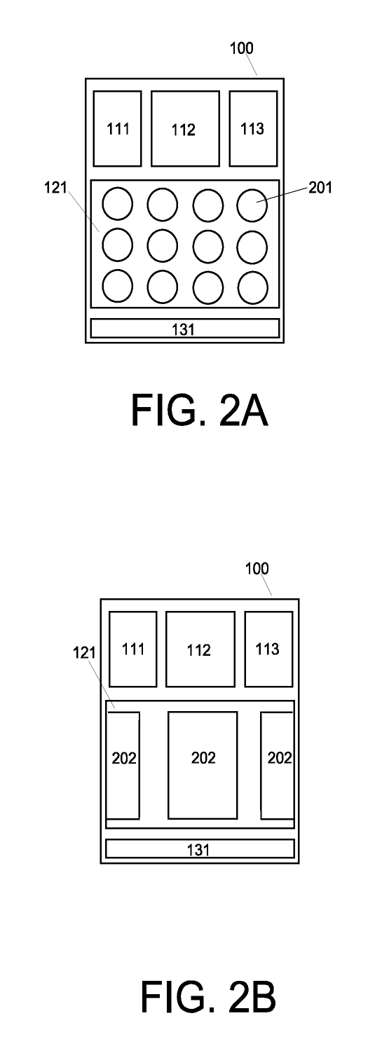

FIG. 2A shows an example of the selection display 121 displaying buttons 201 associated with the characteristics of the patient display 170. By use of the settings buttons 201 a patient may be able to select e.g. intensity, color and or sound volume of the patient display 170. The selection display 121 may be configured so that when a setting or button 201 is selected a circle around the button will be visually displayed or high-lighted, e.g. by displaying a bright colored circle and so that when a button 201 is deselected the circle around the button will be visually deselected, e.g. by displaying a grey circle. The user interface 100 may be configured so that when a selection of a setting has been performed via the selection display 121 the color, lighting intensity or sound volume will be immediately changed on the patient display 170 in the patient room. Also color and lighting intensity will be immediately changed on a display component 111-113 displaying the same images or corresponding images (e.g. a representative still image) as on the patient display 170.

FIG. 2B shows an example of the selection display 121 for displaying selectable visual objects 202, e.g. for the first and second display components 112, 113. The selectable visual objects 202 may show image content corresponding to a video or a still image to be displayed on a display component 111-113 and on the patient display 170. For example, when a video theme has been selected via a selectable visual object 202, i.e. a selectable image button 202 the frame around the button may be visually selected, e.g. by making the frame green, and when the video theme is deselected the frame around the button may be visually deselected, e.g. by making the frame grey. Different image buttons 202 corresponding to different visual object, i.e. different video themes and/or connectivity images, may be displayed in the selection display, e.g. by swiping buttons 202 to the left or right. The selectable image buttons 202 may be selected by user interaction, e.g. via eye movement or by touching the image buttons 202 in case that the display is touch sensitive.

In general, the display components 111-113, and/or the selectable visual objects 201-202 may be configured so that the display component or buttons change appearance in response to being selected or deselected by the user.

Accordingly, the selection display 121 may be configured so that the selectable visual objects 202 for the first display component 112 are displayed in response to selection of the first display component 112, so that the selectable visual objects 202 for the second display component 113 are displayed in response to selection of the second display component 113, and so that setting buttons 201 are displayed in response to selection of the setting component.

The user interface 100 may be configured so that the size of the user interface, i.e. vertical and horizontal dimensions, automatically adapt in dependence of the size of the screen 198 of the user display 199. Similarly, the buttons 201, 202 may change in size and spacing depending on the size of the screen 198.

Stroke victims may experience a neglect phenomenon wherein the patient is not able to see objects to the right or left in the field of vision, or have difficulties with perceiving objects located non-centrally in the field of vision. Accordingly, the user interface 100 may be configured so that e.g. a selectable visual object 202 is always displayed in the center of the screen 198 or in the center of the selection display 121. Thereby, the user interface 100 may improve user friendliness for patients with reduced capabilities for viewing non-centered objects.

The buttons 201 are made big enough so that patients with a paralysis, restricted hand movement or less control over hand coordination can still use the user interface 100. For example, the buttons 201, 202 of the selection display 121 may have a minimum diameter of 1 cm in case of circular buttons, a minimum size wherein at least one of the sides are larger than 1 cm in case of rectangular or square buttons. Thereby, patients with reduced capabilities for selecting a button may be experience eased operation of the selection display 121. The distance between buttons may be made large enough to minimize undesired selection of neighbour buttons 201. The buttons 201, 202 may be displayed as 2D or 3D buttons.

The user interface 100 may be configured so that it is configurable to display one or more of the at least first and second a display components 111-113 so that a number or type of selectable display components can be adapted to the patient's current capability of handling more or less display components 111-113. Alternatively or additionally, the user interface 100 may be configurable to disable the selectability one or more of the at least first and second display components 111-113. In this way a display component may be displayed but without being selectable.

Alternatively or additionally, the user interface 100 may be configured so that an available number of setting-buttons 201 and/or so that available setting-types of the settings component 131 is configurable. Additionally or alternatively, the user interface 100 may be configured so that an available number of selectable visual objects 202 is configurable. In this way the number of buttons 201, 202 can be adjusted to meet the patient's capability of handling a user interface.

The configurability of the user interface 100 may enable one or more of adjustment of the number or type of selectable display components, adjustment of selectability of display components, adjustment of the available number of setting-buttons 201 and/or available setting-types of the settings component 131 and adjustment of the available number of selectable visual objects 202.

This configurability may be embodied at least in part by a staff control function enabling staff of a e.g. a hospital, e.g. a nurse, to set patient parameters which are useable by the user interface 100 to make the above-mentioned adjustments, e.g. adjustment of the available number of selectable visual objects 202. The staff control function may be a user input device e.g. a user interface of a touch-sensitive display connected to the database 180.

Accordingly, staff personnel can set patient parameters on the database 180 via the user input device, which parameters are retrievable by the user interface 100 for automatically adjusting the user interface 100. The parameter or parameters for adjusting the user interface 100 may be in the form of one or more stimulus load values indicating how much load the patient can handle. Alternatively or additionally, the staff control function may be embodied by a password protected user interface of the user display 199 dedicated for staff personnel for making adjustments of the user inter face 100.

Alternatively or additionally, the configurability may be embodied a patient system configured to determine the patient parameters from measurements and/or from patient interaction with the user interface 100.

Accordingly, the patient system may be configured to determine the patient parameters from measured conditions of a patient. Such measured conditions may be obtained from various clinical devices capable of measuring for example blood pressure, heart rate, skin conductivity, respiration rate, body temperature, skin color and facial expressions.

The user interface may be configured to determine patient parameters from patient interaction by monitoring how the patient uses the user interface 100, e.g. by monitoring how well the patient is capable of selecting buttons 201, 202 or the number of times that a patient interacts with the user interface within a given time.

Thus, in general the user interface 100 may be automatically configurable based on patient parameters retrievable by the user interface 100 from a database e.g. the database 180 or other database where the patient parameters, e.g. patient load stimulus parameters, may have been supplied by personnel or may have been determined from measurements relating to the patient or from patient interaction with the user interface.

The process of controlling visual content on a patient display 170 located in front of a patient by use a user display 199 having a user interface 100, wherein the user display comprises a transmitter 141 for transmitting interaction data derived from patient interaction with the user interface and a receiver 142 for receiving visual object data may comprise one or more of the following steps:

1) displaying a display component 111-113 for displaying visual objects created from the visual object data, wherein the display component is selectable by the patient for selection of different visual objects.

2) generating first interaction data in response to the patient's selection of the display component. The interaction data may contain information indicating which display component has been selected.

3) in response to the first interaction data, displaying (e.g. on a selection display 121) selectable visual objects 202. A given selectable visual object may contain or display visual content such as still images determined from visual object data retrieved from the database 180.

4) generating second interaction data in response to the patient's selection of one or more of the selectable visual objects (202). The second interaction data may contain information indicating which objects have been selected.

5) in response to the second interaction data, displaying the selected visual objects on the selected display component 111-113 and displaying visual content on the patient display, wherein the visual objects displayed on the display component and the visual content displayed on the patient display are determined from the same visual object data. In case that a selected visual object corresponds to video, the visual object displayed on the display component 111-113 may be a still image derived from the visual object data which also generates the video. Alternatively, the visual object displayed on the display component 111-113 may be a video being identical to the video displayed on one of the patient display units 171-173. In case that a selected visual object or selected objects corresponds to an image or a selection of images, e.g. connectivity images, one of the selected images, a selection of at least two of the selected images or all the selected images may be displayed on the display component 111-113 whereas all selected images are display on the display unit 171-173 associated with the display component 111-113.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, database or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A user interface for enabling a patient to control visual content on first and second display units of a patient display located in front of the patient, wherein
the user interface is processable by a user display to display the user interface, wherein the user display is responsive to generate data derived from patient interaction with the user interface, and wherein the user display comprises a transmitter for transmitting the data derived from patient interaction with the user interface and a receiver for receiving visual object data, wherein the user interface comprises
at least first and second a display components for displaying at least first and second visual objects created from the visual object data, wherein the first and second display components are selectable by the patient for selection of different visual objects for each of the first and second display components, and wherein the first and second display components are synchronized with the first and second display units so that the visual objects displayed on the first and second display components and the visual content shown of the first and second display units are determined from the same visual object data.

2. A user interface according to claim 1, wherein the synchronization of the display component with the patient display is achieved by the transmitter and receiver.

3. A user interface according to claim 1, further comprising
a settings component being selectable by the patient for setting characteristics of the patient display, wherein the settings component is configured so that selection of the settings component causes a presentation on the user interface of different setting buttons associated with the characteristics of the patient display.

4. A user interface according to claim 3, further comprising
a selection display for displaying selectable visual objects the first and second display components and for displaying the setting buttons associated with the settings component, wherein the user interface is configured so that the selectable visual objects for the first display component are displayed in response to selection of the first display component, so that the selectable visual objects for the second display component are displayed in response to selection of the second display component, and so that setting buttons are displayed in response to selection of the setting component.

5. A user interface according to claim 4, wherein the user interface is configured to display one or more of the selectable visual objects and/or setting buttons in the center of the selection display.

6. A user interface according to claim 1, wherein the user interface is configurable to display one or more of the at least first and second a display components.

7. A user interface according to claim 1, wherein the user interface is configurable so that an available number of setting buttons and/or an available number of selectable visual objects is configurable.

8. A user interface according to claim 6, wherein the user interface is configurable based on patient parameters retrievable by the user interface from a database.

9. A user interface according to claim 8, wherein the patient parameters are provided from measured conditions of a patient.

10. A patient experience system, comprising:
a user interface according to claim 1,
the user display, and
the patient display comprising the first and second display units.

11. A method for enabling a patient to control visual content on first and second display units of a patient display located in front of the patient, wherein
the user interface is processable by a user display to display the user interface, wherein the user display is responsive to generate data derived from patient interaction with the user interface, and wherein the user display comprises a transmitter for transmitting the data derived from patient interaction with the user interface and a receiver for receiving visual object data, wherein the method comprises
displaying at least first and second a display components for displaying at least first and second visual objects created from the visual object data, wherein the first and second display components are selectable by the patient for selection of different visual objects for each of the first and second display components, and
synchronizing the first and second display components with the first and second display units so that the visual objects displayed on the first and second display components and the visual content shown of the first and second display units determined from the same visual object data.

12. A computer program product comprising program code instructions which when executed by a processor of a user display enables the user display to carry out the method of claim 11.

13. A computer-readable medium comprising a computer program product according to claim 12.

14. A user display comprising the user interface of claim 1.
